(19) United States
(12) Patent Application Publication
(10) Pub. No.: US 2023/0376746 A1
(43) Pub. Date: Nov. 23, 2023

(54) SYSTEMS AND METHODS FOR NON-STATIONARY TIME-SERIES FORECASTING

(71) Applicant: Salesforce.com, inc., San Francisco, CA (US)

(72) Inventors: Gerald Woo, Singapore (SG); Chenghao Liu, Singapore (SG); Doyen Sahoo, Singapore (SG); Chu Hong Hoi, Singapore (SG)

(21) Appl. No.: 17/939,085

(22) Filed: Sep. 7, 2022

Related U.S. Application Data
(60) Provisional application No. 63/343,274, filed on May 18, 2022.

(51) Int. Cl. G06N 3/08; G06N 3/04

(52) U.S. Cl. CPC G06N 3/08; G06N 3/0481

(57) ABSTRACT

Embodiments described herein provide a time-index model for forecasting time-series data. The architecture of the model takes a normalized time index as an input, uses a model, g_φ, to produce a vector representation of the time-index, and uses a “ridge regressor” which takes the vector representation and provides an estimated value. The model may be trained on a time-series dataset. The ridge regressor is trained for a given g_φ to reproduce a given lookback window. g_φ is trained over time-indexes in a horizon window, such that g_φ and the corresponding ridge regressor will accurately predict the data in the horizon window. Once g_φ is sufficiently trained, the ridge regressor can be updated based on that final g_φ over a lookback window comprising the time-indexes with the last known values. The final g_φ together with the updated ridge regressor can be given time-indexes past the known values, thereby providing forecasted values.

### CROSS REFERENCE(S)

The instant application is a nonprovisional of and claim priority under 35 U.S.C. 119 to U.S. provisional application no. 63/343,274, filed May 18, 2022, which is hereby expressly incorporated by reference herein in its entirety.

### TECHNICAL FIELD

The embodiments relate generally to time-series forecasting and machine learning systems, and more specifically to systems and methods for non-stationary time-series forecasting.

### BACKGROUND

A time series is a set of values that correspond to a parameter of interest at different points in time. Examples of the parameter can include prices of stocks, temperature measurements, and the like. Time series forecasting is the process of determining a future datapoint or a set of future datapoints beyond the set of values in the time series. For example, a prediction of the stock prices into the next trading day is a time series forecast. Deep learning models have been used for time-series forecasting. For example, existing systems may adopt auto-regressive architectures such as Transformer-based models for time-series forecasting. These models are often limited due to their complex parameterization relying on discrete time steps, while the underlying time-series is often a continuous signal.

Therefore, there is a need for improved systems and methods for time-series forecasting.

### BRIEF DESCRIPTION OF THE DRAWINGS

FIG. 1 is a simplified diagram illustrating a time-series forecasting model according to some embodiments.

FIG. 2 is a simplified diagram illustrating a meta-learning method for training a time-series forecasting model according to some embodiments.

FIG. 3 illustrates a deep time-index model with and without the proposed meta-learning formulation according to some embodiments.

FIG. 4 is a simplified diagram illustrating a computing device implementing the deep time-index meta-learning (DeepTIMe) framework described in FIGS. 1-3, according to one embodiment described herein.

FIG. 5 is a simplified block diagram of a networked system suitable for implementing the DeepTIMe framework described in FIGS. 1-2 and other embodiments described herein.

FIG. 6 is an example logic flow diagram illustrating a method of training a time-series forecasting model based on the framework shown in FIGS. 1-2, according to some embodiments described herein.

FIGS. 7-14 provide charts illustrating exemplary performance of different embodiments described herein.

FIG. 15 provides an exemplary pseudo-code algorithm for a closed-form ridge regressor according to some embodiments.

FIG. 16 provides an exemplary pseudo-code algorithm for the DeepTIMe framework according to some embodiments.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

Deep learning models have been used for time-series forecasting, e.g., given time-series data from a prior time period, the deep learning models may predict time-series data over a future time period. For example, existing systems may adopt auto-regressive architectures such as Transformer-based models for time-series forecasting. These models are often limited due to their complex parameterization relying on discrete time steps, while the underlying time-series is often a continuous signal.

In view of the need for efficient systems and methods for time-series forecasting, embodiments described herein provide a time-index model for forecasting time-series data, referred to as “DeepTIMe.” The architecture of the model takes a normalized time index as an input, using a model, g_{ϕ}, to produce a vector representation of the time-index. The framework then uses a “ridge regressor” which takes the vector representation and provides an estimated value of the time-series sequence at the specified time index. The entire model (including g_{ϕ} and the ridge regressor) is trained on a single time-series dataset. The time-series dataset is divided into lookback windows and horizon windows. The ridge regressor is trained for a given g_{ϕ} to reproduce a given lookback window. g_{ϕ} is trained over time-indexes in the horizon window, such that g_{ϕ} and the corresponding ridge regressor will accurately predict the data in the horizon window.

Once g_{ϕ} sufficiently trained, the ridge regressor can be updated based on that final g_{ϕ} over a lookback window comprising the time-indexes with the last known values. The final g_{ϕ} together with the updated ridge regressor can be given time-indexes past the known values, thereby providing forecasted values. In other words, the training of the ridge regressor may be considered an inner-loop optimization to minimize a first training objective while updating the parameters of the ridge regressor, which is done between outer-loop optimizations of g_{ϕ}, which minimizes a second training objective while updating the parameters of g_{ϕ} with the parameters of the ridge regressor temporarily frozen. In this way, the training process is completed within a bi-level meta-learning paradigm.

Embodiments described herein improve the efficiency of time-series forecasting. For example, the architecture is more efficient in terms of memory and compute while providing similar or better results that alternative forecasting models. This is realized at least in part by utilizing time-indexes as inputs to the model, rather than an entire sequence. The meta-learning formulation allows for the accurate use of a time-index based model. The model described herein is also accurate for a longer horizon than similar models, which allows a system to recompute a forecast with lower frequency, conserving additional compute and power resources.

The accuracy and efficiency in time-series forecasting may help to improve training performance and systems of time-series processing systems, such as a neural network-based prediction system that predicts the likelihood of a diagnostic result (e.g., specific heart beat patterns, etc.), a network monitor that predicts network traffic and delay over a time period, an electronic trading system that makes trading decisions based on time-series data reflecting market dynamics and portfolio performance over time, and/or the like.

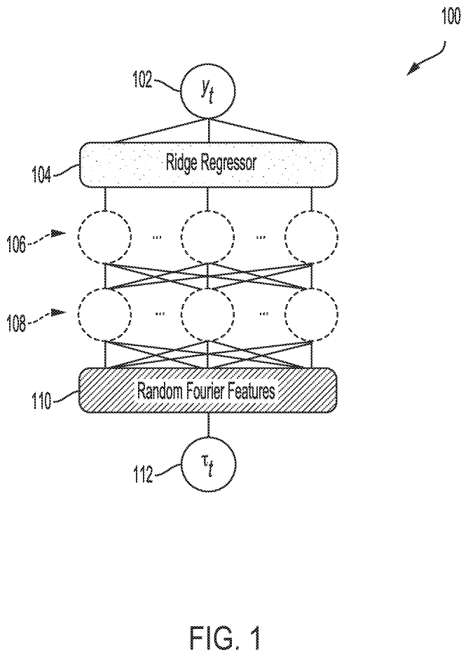

FIG. 1 is a simplified diagram illustrating a time-series forecasting model 100 according to some embodiments. The model 100 comprises a random Fourier features input layer 110, internal multi-layer perceptron (neural network) layers 106 and 108, and a ridge regressor 104. The structure show in FIG. 1 is for illustrative purpose only. For example, additional internal layers that are not shown may be included in the model 100.

The model may be considered as a member of a class of models called Implicit Neural Representations (INR). This class of deep models maps coordinates to the value at that coordinate using a stack of multi-layer perceptrons (MLPs). Here, the model is configured to map a time-index to the value of the time-series at that time index. The model as shown in FIG. 1 may be described in the following form:

z⁽⁰⁾=τ

z^{(k+1)}=max(0, W^{(k)}z^{(k)}+b^{(k)}), k=0, . . . , K−1

[symbol]

_{θ}(τ)=W^{(K)}z^{(K)}+b^{(K)}

where τ∈ [symbol] ^{C} is the time-index. In some embodiments, c=1, but τ∈ [symbol] ^{C} is general to allow for cases where datetime features are included. As discussed below, z⁽⁰⁾ may be modified using random Fourier features in order to allow the model to fit to high frequency functions.

In one embodiment, random Fourier features input layer 110 has an input of a normalized time index 112. The time index 112 is normalized to the size of the lookback and horizon windows, such that each of those windows is of length 1. Given a normalized time index 112 as an input, the random Fourier features input layer 110 allows the model to fit to high frequency functions, by modifying the normalized time index 112 with sinusoids. In some embodiments, the normalized time index 112 is modified as:

γ(τ)=[sin(2πBτ), cos(2πBτ)]^{T}

where τ is the normalized time index 112, B∈ [symbol] ^{d/2xc} sampled from [symbol] (0, σ²) with d as a hidden dimension size of the model and σ² is a hyperparameter. [.,.] is a row-wise stacking operation.

To reduce the fine-tuning of hyper-parameters, the random Fourier features input layer 110 may comprise concatenated Fourier features, where multiple Fourier basis functions with diverse scale parameters are used. For example:

γ(τ)=[sin(2πB₁τ), cos(2πB₁τ), . . . , sin(2πB_{S}τ), cos(2πB_{S}τ)]^{T}

where elements in B_{f}∈ [symbol] ^{d/2xc} are sampled from [symbol] (0, σ_{S}²) and the next layer of the model, W⁰∈ [symbol] ^{dxSd}.

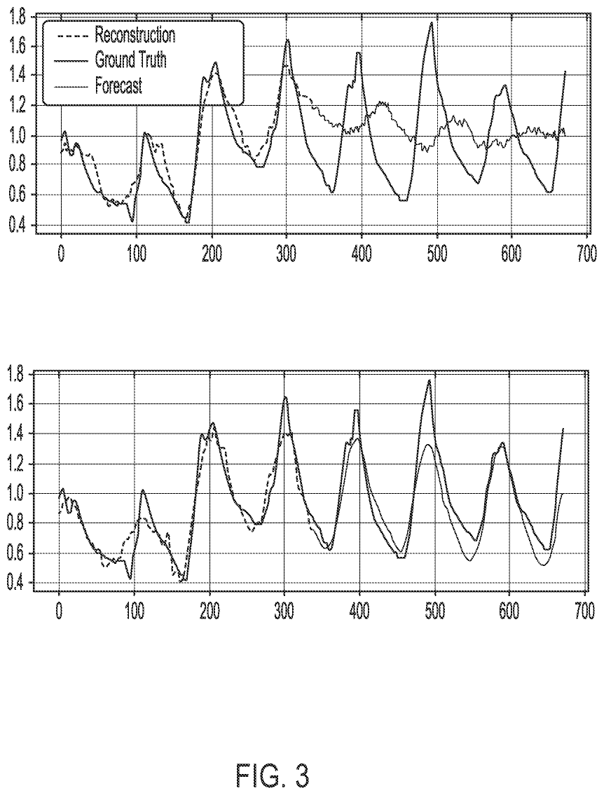

Ridge regressor 104 may be the final layer of the model which provides output y, which is the predicted value of the time-series at normalized time index 112. As described in more detail with respect to FIG. 3, the ridge regressor 104 and the other layers (e.g., 106 and 108) are trained iteratively in a meta-learning formulation.

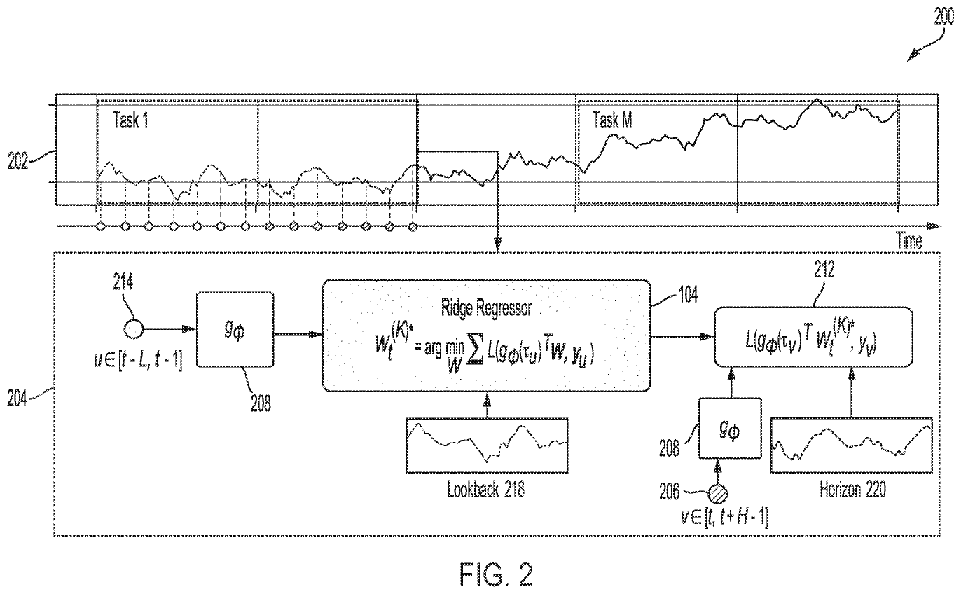

FIG. 2 is a simplified diagram 200 illustrating a meta-learning method for training a time-series forecasting model according to some embodiments. The top portion 202 of the diagram illustrates a time-series sequences which is divided into tasks (e.g., Task 1 and Task M). The sequence has values across those tasks, which may be sampled at intervals as illustrated. Each task may be divided into a lookback window, and a horizon window, each of equal length (number of samples). The model as described in FIG. 1 may be trained over a number of tasks within the same time-series sequence.

The lower portion 204 of diagram 200 illustrates a simplified diagram for training the model (e.g., model 100) for time-series forecasting. The basic method of training the model comprises inner and outer optimization loops. The inner loop comprises training the ridge regressor 104 for a given g₉₉ 208 to reproduce a given lookback window 218 with an input of normalized time indexes 214 associated with lookback window 218. The outer loop comprises minimizing loss 212 by learning parameters of g_{ϕ} 208 over the corresponding horizon window 220, such that g_{ϕ} 208 and the corresponding ridge regressor 104 will accurately predict the data in the horizon window 220 using the input of normalized time indexes 206 associated with horizon window 220.

The outer loop is performed by optimizing g_{ϕ} 208 (using parameters ϕ) over a horizon window 220 The inner loop is performed by optimizing ridge regressor 104 for a given g_{ϕ} 208, which represents the random Fourier features layer and other model layers with current parameters ϕ. Ridge regressor 104 is optimized for each task over the corresponding lookback window 218. The following detailed description provides the mathematical basis for the training method.

In long sequence time-series forecasting, the time-series dataset (y₁, y₂, . . . , y_{T}), where yₜ∈ [symbol] ^{m} is the m-dimension observation at time t. Given a lookback window T_{t-L:t}=[y_{t-L}; . . . ; yₜ₋₁]^{T}∈z,27 ^{Lxm} of length L, the aim is to construct a point forecast over a horizon of length H, Y_{t:t+H}=[yₜ; . . . ; y_{t+H-1}]^{T}∈ [symbol] ^{Hxm} by learning a model [symbol] : [symbol] ^{Lxm}→ [symbol] ^{Hxm} which minimizes some loss function [symbol] : [symbol] ^{Hxm}× [symbol] ^{Hxm}→ [symbol] .

To formulate time-series forecasting as a meta-learning problem, each paired lookback window 218 and horizon window 220 are treated as a task. Specifically, the lookback window 218 is treated as the support set, and horizon window 220 is treated as the query set. Each time coordinate and time-series value pair, (τₜ₊ᵢ, yₜ₊ᵢ), is an input-output sample, i.e.,

[symbol]

^{s}=(τ_{t-L}, y_{t-L}), . . . , (τₜ₋₁, yₜ₋₁), [symbol] ^{q}=(τₜ, yₜ), . . . , ( τ_{t+H-1}, y_{t+H-1})

where τₜ₊ᵢ=i+L/L+H−1 Is a [0,1]-normalized time-index. The forecasting model, [symbol] : [symbol] → [symbol] ^{m}, is then parameterized by ϕ and θ, the meta and base parameters respectively, and the bi-level optimization problem can be formalized as:

$$ϕ *= {arg min}_{ϕ} {\sum }_{t = L + 1}^{T - H + 1} {\sum }_{j = 0}^{H - 1} ℒ ( 𝒻 ( {τ}_{t + j} ; {θ}_{t}^{*} , ϕ ) , {y}_{t + j} )$$

$$s . t . {θ}_{t}^{*} = {arg min}_{θ} {\sum }_{j = - L}^{- 1} ℒ ( 𝒻 ( {τ}_{t + j} ; θ , ϕ ) , {y}_{t + j} )$$

In the above equations, the outer summation in the first equation over index t represents each lookback-horizon window, corresponding to each task in meta-learning, and the inner summation over index j represents each sample in the query set, or equivalently, each time step in the horizon window 220. The summation in the second equation over index j represents each sample in the support set, or each time step in the lookback window 218.

As illustrated, loss 212 is a function of g_{ϕ} 208 with an input of time-series indexes over the horizon window (τᵥ), the ridge regressor (Wₜ^{(K)}) which is parameterized by θ, and the horizon window values yᵥ. Ridge regressor 104 as illustrated is optimized at each step t to minimize a loss which is a function of the current g_{ϕ} 208 with an input of time-series indexes over the lookback window (τᵤ), the current ridge regressor (W) as parameterized by θ, and the lookback window values yᵤ.

The meta-learning formulation allows DeepTIMe to restrict the hypothesis class of the representation function, from the space of all K-layered networks, to the space of K-layered networks conditioned on the optimal meta parameters, [symbol] ={ [symbol] (τ, θ, ϕ*)|θ∈Θ}, where the optimal meta parameters, ϕ*, is the minimizer of a forecasting loss (as specified in the first equation above). Given this hypothesis class, local adaptation is performed over [symbol] given the lookback window 218, which is assumed to come from a locally stationary distribution, resolving the issue of non-stationarity.

The inner and outer loops of training may be performed over a number of tasks (lookback-horizon window pairs) of the time-series sequence. Once sufficiently trained, the lookback window 218 may be set over the time indexes which are the final time indexes for which values are known in the given time-series sequence. The ridge regressor 104 may be optimized for the learned g_{ϕ} 208, and time indexes in the forecast horizon window may be input to the model, which will provide predicted values for each of the input time indexes.

The ridge regressor 104 may be optimized using gradient descent to learn the optimal parameters. Alternatively, ridge regressor 104 may be optimized via a closed-form solver. Using a closed-form solver on the ridge regressor 104 is especially beneficial as it is the inner loop of the meta-learning formulation, and therefore is optimized frequently during training. A ridge-regression closed-form solver may restrict the inner loop to only apply to the last layer of the model, allowing for either a closed-form solution or differentiable solver to replace an inner gradient step. This means the for a K-layered model, g_{ϕ} 208 parameters ϕ={W⁽⁰⁾, b⁽⁰⁾, . . . , W^{(K-1)}, b^{(K-1)}, λ} are the meta parameters and the ridge regressor 104 parameters θ={W^{(K)}} are the base parameters. Then let g_{ϕ}: [symbol] → [symbol] ^{d} Be the meta learner where g_{ϕ}(τ)=z^{(K)}. For task t with the corresponding lookback-horizon pair, (Y_{t-L:t}, Y_{t:t+H}), the support set features obtained from the meta learner is denoted Z_{t-L:t}=[g_{ϕ}(τ_{t-L}); . . . ; g_{ϕ}(τₜ₋₁)]^{T}∈ [symbol] ^{Lxd}, where [.;.] is a column-wise concatenation operation. The inner loop thus solves the optimization problem:

$${W}_{T}^{( K ) *} = {arg min}_{W} {‖ {Z}_{t - L : t} W - {Y}_{t - L : t} ‖}^{2} + λ {‖ W ‖}^{2} = {( {Z}_{t - L : t}^{T} {Z}_{t - L : t} + λ I )}^{- 1} {Z}_{t - L : t}^{T} {Y}_{t - L : t}$$

Now, let Z_{t:t+H}=[g_{ϕ}(τₜ); . . . ; g_{ϕ}(τ_{t+H-1})]^{T}∈ [symbol] ^{Hxd} Be the query set features. Then the predictions are Y_{t:t+H}=Z_{t:t+H}Wₜ^{(K)*} . This closed-form solution is differentiable, which enables gradient updates on the parameters of the meta learner ϕ. A bias term can be included for the closed-form ridge regressor by appending a scalar 1 to the feature vector g_{ϕ}(τ). The model obtained by DeepTIMe is ultimately the restricted hypothesis class [symbol] ={g_{ϕ}*(τ)^{T}W^{(K)}|W^{(K)}∈ [symbol] ^{dxm}}.

In some embodiments, DeepTIMe may be trained with an “Adam” optimizer as described in Kingma and Ba, Adam: A method for stochastic optimization, arXiv 1412.6980, 2014. The optimizer may have a learning rate scheduler following a linear warm up and cosine annealing scheme. Gradient clipping by norm may be applied. The ridge regressor regularization coefficient, λ, may be trained with a different, higher learning rate than the rest of the meta parameters. Early stopping may be used based on the validation loss, with a fixed patience hyperparameter (number of epochs for which loss deteriorates before stopping).

The ridge regression regularization coefficient is a learnable parameter which may be constrained to positive values via a softplus function. After the ReLU activation function in each INR layer, a Dropout, then a LayerNorm may be applied, where Dropout is as described in Srivastava et al., Dropout: a simple way to prevent neural networks from overfitting, The journal of machine learning research, 15(1):1929-1958, 2014; and Layernorm as described in Ba et al., Layer normalization, arXiv 1607.06450, 2016.

Predicted values may be used in a number of ways. For example, a system may preemptively make adjustments to system parameters based on predicted values. Predicted values may also be displayed to a user on a user-interface display.

FIG. 3 illustrates a comparison of forecasting methods according to some embodiments. The top graph represents a naive deep time-index model without meta-learning. As shown, while it manages to fit the historical data, it is too expressive, and without any inductive biases, cannot extrapolate. In contrast, the bottom graph illustrates exemplary results using a DeepTIMe meta-learning formulation. As illustrated, the model is successfully trained to find the appropriate function representation and is able to extrapolate.

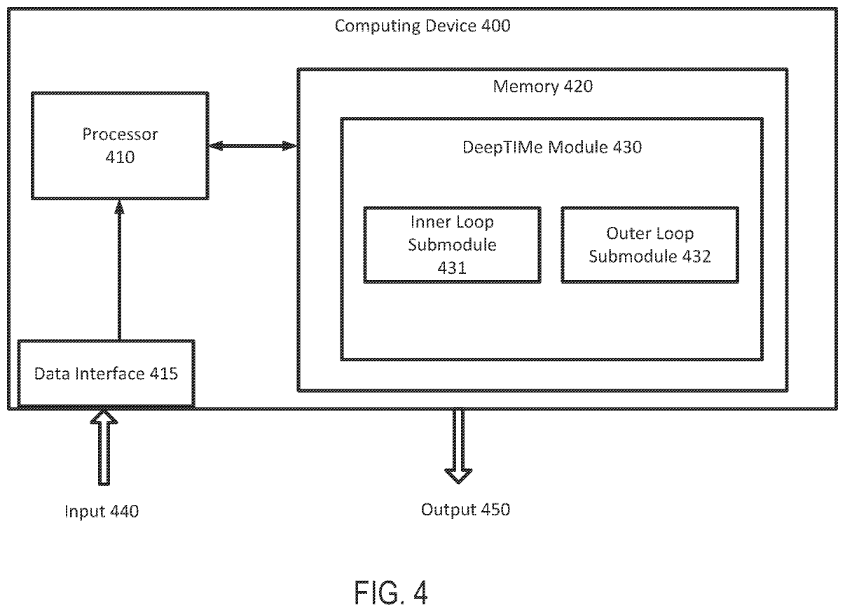

FIG. 4 is a simplified diagram illustrating a computing device implementing the DeepTIMe frameword described in FIGS. 1-2, according to one embodiment described herein. As shown in FIG. 4, computing device 400 includes a processor 410 coupled to memory 420. Operation of computing device 400 is controlled by processor 410. And although computing device 400 is shown with only one processor 410, it is understood that processor 410 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 400. Computing device 400 may be implemented as a stand-alone subsystem, as a board added to a computing device, and/or as a virtual machine.

Memory 420 may be used to store software executed by computing device 400 and/or one or more data structures used during operation of computing device 400. Memory 420 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 410 and/or memory 420 may be arranged in any suitable physical arrangement. In some embodiments, processor 410 and/or memory 420 may be implemented on a same board, in a same package (e.g., system-in-package), on a same chip (e.g., system-on-chip), and/or the like. In some embodiments, processor 410 and/or memory 420 may include distributed, virtualized, and/or containerized computing resources. Consistent with such embodiments, processor 410 and/or memory 420 may be located in one or more data centers and/or cloud computing facilities.

In some examples, memory 420 may include non-transitory, tangible, machine readable media that includes executable code that when run by one or more processors (e.g., processor 410) may cause the one or more processors to perform the methods described in further detail herein. For example, as shown, memory 420 includes instructions for DeepTIMe module 430 that may be used to implement and/or emulate the systems and models, and/or to implement any of the methods described further herein. An DeepTIMe module 430 may receive input 440 such as an input training data (e.g., one or more time-series sequences) via the data interface 415 and generate an output 450 which may be a model or predicted forecast values. Examples of the input data may include electrocardiogram (ECG) data, weather data, stock data, etc. Examples of the output data may include future predictions based on the input data, or control signals based on the predictions.

The data interface 415 may comprise a communication interface, a user interface (such as a voice input interface, a graphical user interface, and/or the like). For example, the computing device 400 may receive the input 440 (such as a training dataset) from a networked database via a communication interface. Or the computing device 400 may receive the input 440, such as time-series data, from a user via the user interface.

In some embodiments, the DeepTIMe module 430 contains a model (e.g. model 100) and is configured to train the model for time-series data predictions and/or infer predictions over a forecast horizon. The DeepTIMe module 430 may further include an inner loop submodule 431 and outer loop submodule 432. In one embodiment, the DeepTIMe module 430 and its submodules 431-432 may be implemented by hardware, software and/or a combination thereof. Inner loop submodule 431 may be configured to perform inner loop optimization of the ridge regressor as described with respect to FIG. 2 and other embodiments herein. Outer loop submodule 432 may be configured to perform outer loop optimization of the model as described with respect to FIG. 2 and other embodiments herein.

Some examples of computing devices, such as computing device 400 may include non-transitory, tangible, machine readable media that include executable code that when run by one or more processors (e.g., processor 410) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

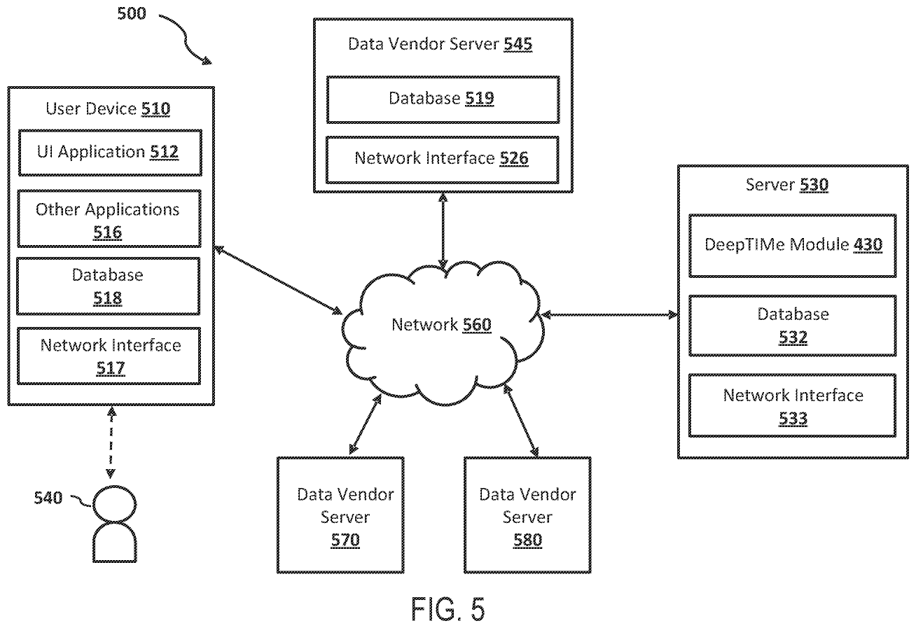

FIG. 5 is a simplified block diagram of a networked system suitable for implementing the DeepTIMe framework described in FIGS. 1-2 and other embodiments described herein. In one embodiment, block diagram 500 shows a system including the user device 510 which may be operated by user 540, data vendor servers 545, 570 and 580, server 530, and other forms of devices, servers, and/or software components that operate to perform various methodologies in accordance with the described embodiments. Exemplary devices and servers may include device, stand-alone, and enterprise-class servers which may be similar to the computing device 400 described in FIG. 4, operating an OS such as a MICROSOFT® OS, a UNIX® OS, a LINUX® OS, or other suitable device and/or server-based OS. It can be appreciated that the devices and/or servers illustrated in FIG. 5 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 510, data vendor servers 545, 570 and 580, and the server 530 may communicate with each other over a network 560. User device 510 may be utilized by a user 540 (e.g., a driver, a system admin, etc.) to access the various features available for user device 510, which may include processes and/or applications associated with the server 530 to receive an output data anomaly report.

User device 510, data vendor server 545, and the server 530 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 500, and/or accessible over network 560.

User device 510 may be implemented as a communication device that may utilize appropriate hardware and software configured for wired and/or wireless communication with data vendor server 545 and/or the server 530. For example, in one embodiment, user device 510 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 510 of FIG. 5 contains a user interface (UI) application 512, and/or other applications 516, which may correspond to executable processes, procedures, and/or applications with associated hardware. For example, the user device 510 may receive a message indicating future value predictions, or some other output based on the predictions from the server 530 and display the message via the UI application 512. In other embodiments, user device 510 may include additional or different modules having specialized hardware and/or software as required.

In various embodiments, user device 510 includes other applications 516 as may be desired in particular embodiments to provide features to user device 510. For example, other applications 516 may include security applications for implementing client-side security features, programmatic client applications for interfacing with appropriate application programming interfaces (APIs) over network 560, or other types of applications. Other applications 516 may also include communication applications, such as email, texting, voice, social networking, and IM applications that allow a user to send and receive emails, calls, texts, and other notifications through network 560. For example, the other application 516 may be an email or instant messaging application that receives a prediction result message from the server 530. Other applications 516 may include device interfaces and other display modules that may receive input and/or output information. For example, other applications 516 may contain software programs for asset management, executable by a processor, including a graphical user interface (GUI) configured to provide an interface to the user 540 to view predictions.

User device 510 may further include database 518 stored in a transitory and/or non-transitory memory of user device 510, which may store various applications and data and be utilized during execution of various modules of user device 510. Database 518 may store user profile relating to the user 540, predictions previously viewed or saved by the user 540, historical data received from the server 530, and/or the like. In some embodiments, database 518 may be local to user device 510. However, in other embodiments, database 518 may be external to user device 510 and accessible by user device 510, including cloud storage systems and/or databases that are accessible over network 560.

User device 510 includes at least one network interface component 517 adapted to communicate with data vendor server 545 and/or the server 530. In various embodiments, network interface component 517 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 545 may correspond to a server that hosts database 519 to provide training datasets including time-series data sequences to the server 530. The database 519 may be implemented by one or more relational database, distributed databases, cloud databases, and/or the like.

The data vendor server 545 includes at least one network interface component 526 adapted to communicate with user device 510 and/or the server 530. In various embodiments, network interface component 526 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 545 may send asset information from the database 519, via the network interface 526, to the server 530.

The server 530 may be housed with the DeepTIMe module 430 and its submodules described in FIG. 1. In some implementations, DeepTIMe module 430 may receive data from database 519 at the data vendor server 545 via the network 560 to generate predicted values over a forecast horizon. The generated predicted values or other information based on the predicted values may also be sent to the user device 510 for review by the user 540 via the network 560.

The database 532 may be stored in a transitory and/or non-transitory memory of the server 530. In one implementation, the database 532 may store data obtained from the data vendor server 545. In one implementation, the database 532 may store parameters of the DeepTIMe module 430. In one implementation, the database 532 may store previously generated predictions, and the corresponding input feature vectors.

In some embodiments, database 532 may be local to the server 530. However, in other embodiments, database 532 may be external to the server 530 and accessible by the server 530, including cloud storage systems and/or databases that are accessible over network 560.

The server 530 includes at least one network interface component 533 adapted to communicate with user device 510 and/or data vendor servers 545, 570 or 580 over network 560. In various embodiments, network interface component 533 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 560 may be implemented as a single network or a combination of multiple networks. For example, in various embodiments, network 560 may include the Internet or one or more intranets, landline networks, wireless networks, and/or other appropriate types of networks. Thus, network 560 may correspond to small scale communication networks, such as a private or local area network, or a larger scale network, such as a wide area network or the Internet, accessible by the various components of system 500.

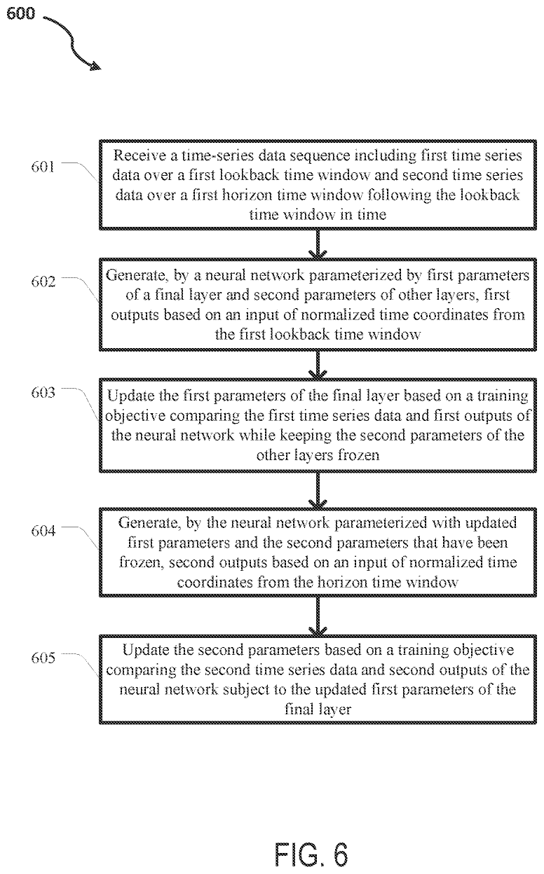

FIG. 6 is an example logic flow diagram illustrating a method of training a time-series forecasting model based on the framework shown in FIGS. 1-2, according to some embodiments described herein. One or more of the processes of method 600 may be implemented, at least in part, in the form of executable code stored on non-transitory, tangible, machine-readable media that when run by one or more processors may cause the one or more processors to perform one or more of the processes. In some embodiments, method 600 corresponds to the operation of the DeepTIMe module 430 (e.g., FIGS. 4-5) that performs the DeepTIMe training method.

As illustrated, the method 600 includes a number of enumerated steps, but aspects of the method 600 may include additional steps before, after, and in between the enumerated steps. In some aspects, one or more of the enumerated steps may be omitted or performed in a different order.

At step 601, a system receives, e.g., via the data interface 415 in FIG. 4, a time-series data sequence including first time series data over a first lookback time window (e.g., see lookback window 218 of FIG. 2) and second time series data over a first horizon time window (e.g., see horizon window 220 in FIG. 2) following the lookback time window in time.

At step 602, the system generates, by a neural network parameterized by first parameters of a final layer (e.g., a ridge regressor 104) and second parameters of other layers (e.g., layers 106 and 108), first outputs based on an input of normalized time coordinates from the first lookback time window.

At step 603, the system updates the first parameters of the final layer based on a training objective comparing the first time series data and first outputs of the neural network while keeping the second parameters of the other layers frozen. For example, the training objective may be computed according to the equation for W_{T}^{(K)*} as described above. Ridge regressor 104 may be optimized as described above with reference to FIG. 2, while the other parameters remain the same. This may be considered the inner-loop training step.

At step 604, the system generates, by the neural network parameterized with updated first parameters and the second parameters that have been frozen, second outputs based on an input of normalized time coordinates from the horizon time window.

At step 605, the system updates the second parameters based on a training objective comparing the second time series data and second outputs of the neural network subject to the updated first parameters of the final layer. For example, the training objective may be computed according to the equation of ϕ* as described above. This may be the outer-loop training step in which parameters of g_{ϕ} are updated based on a loss function with reference to a horizon window. This may complete a single inner/outer loop step, which may be iteratively repeated over different lookback/horizon windows. After completing the training of the model (e.g., after a predetermined number of training steps or as it converges), the model may be used to predict values beyond the received time-series data sequence. A decision may be made based on the predicted values, and/or the predicted values may be presented to a user on a user-interface display.

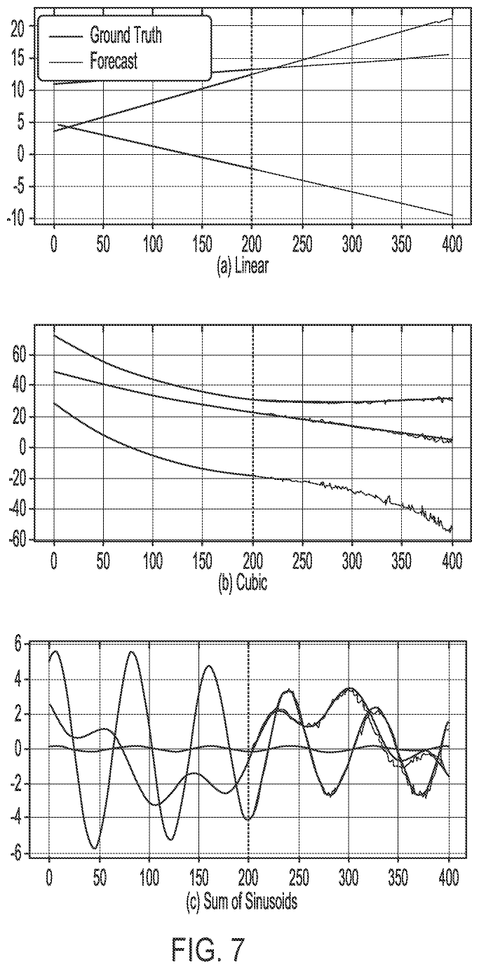

FIGS. 7-14 provide charts illustrating exemplary performance of different embodiments described herein.

FIG. 7 illustrates predictions of DeepTIMe on three unseen functions for each function class. The dotted line in each of the plots represents the lookback and horizon windows, where to the right of each dotted line shows the predicted values. These plots demonstrate that DeepTIMe is able to perform extrapolation on unseen test functions/tasks after being trained via the meta-learning formulation. It demonstrates an ability to approximate and adapt, based on the lookback window, linear and cubic polynomials, and even sums of sinusoids. Linear samples are generated from the function y=ax+b for x∈[−1,1]. This means that each function/task consists of 400 evenly spaced points between −1 and 1. The parameters of each function/task (i.e., a,b) are sampled from a normal distribution with mean 0 and standard deviation of 50. Cubic samples are generated from the function y=ax³+bx²+cx+d f or x∈[−1,1] for 400 points. Parameters of each task are sampled from a continuous uniform distribution with minimum value of −50 and maximum value of 50. Sums of sinusoids are generated from a fixed set of frequencies by sampling ω˜ [symbol] (0,12π). The size is fixed to be five, i.e. Ω={ω₁, . . . , ω₅}. Each function is then a sum of J sinusoids, where J is randomly selected to be from 1 to 5. Amplitude and phase shifts are chosen freely.

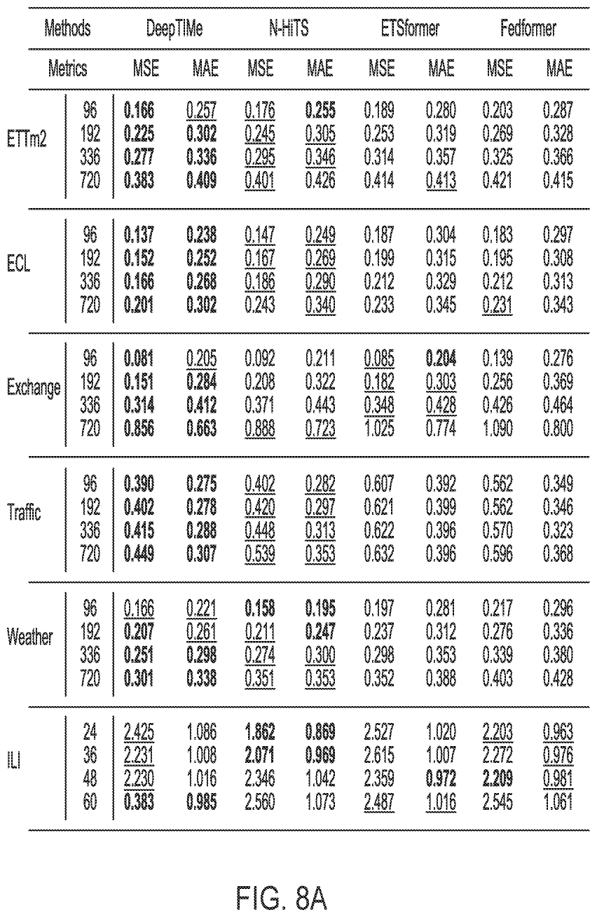

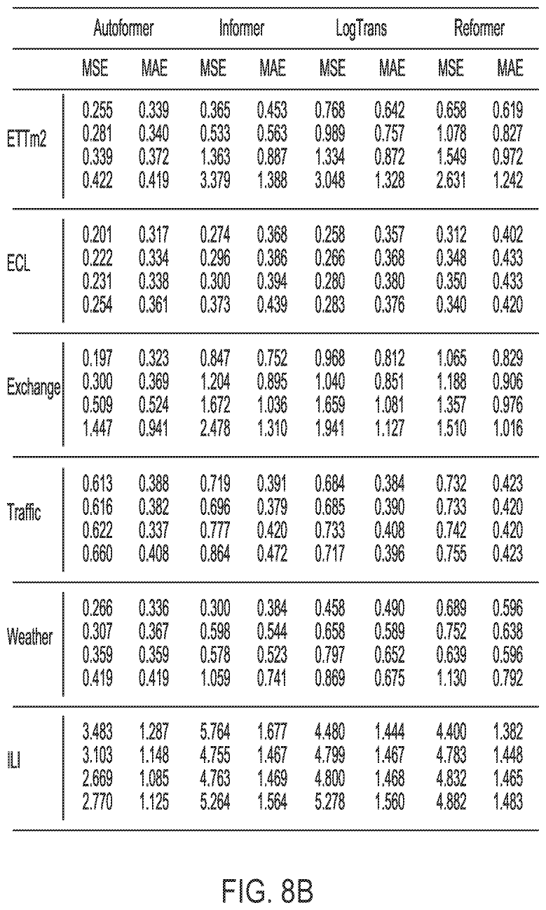

FIG. 8 illustrates a multivariate forecasting benchmark on long sequence time-series forecasting. DeepTIMe is compared to the following baselines: N-HiTS as described in Challu et. aL, N-hits: Neural hierarchical interpolation for time series forecasting, arXiv:2201.12886, 2022; ETSFormer as described in Woo et. aL, Etsformer: Exponential smoothing transformers for time-series forecasting, srXiv:2202.01381, 2022; Fedformer as described in Zhou et. al., Fedformer: Frequency enhanced decomposed transformer for long-term series forecasting, arXiv:2201.12740, 2022; Autoformer as described in Xu et. al., Autoformer: Decomposition transformers with auto-correlation for long-term series forecasting, Advances in Neural Information Processing Systems, 34, 2021; Informer as described in Zhou et. al., Informer: Beyond efficient transformer for long sequence time-series forecasting, In Proceedings of AAAI, 2021; LogTrans as described in Li et. aL, Enhancing the locality and breaking the memory bottleneck of transformer on time series forecasting, arXv, abs/1907.00235, 2019; and Reformer as described in Kitaev et. aL, Reformer: The efficient transformer, In International Conference on Learning Representations, 2020. As shown, deepTIMe achieves the best performance on 20 out of 24 settings for mean squared error (MSE) and 17 out of 24 settings in mean absolute error (MAE).

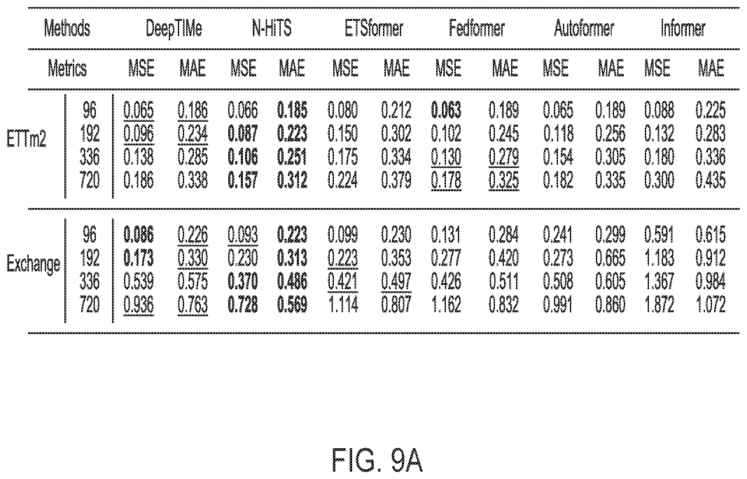

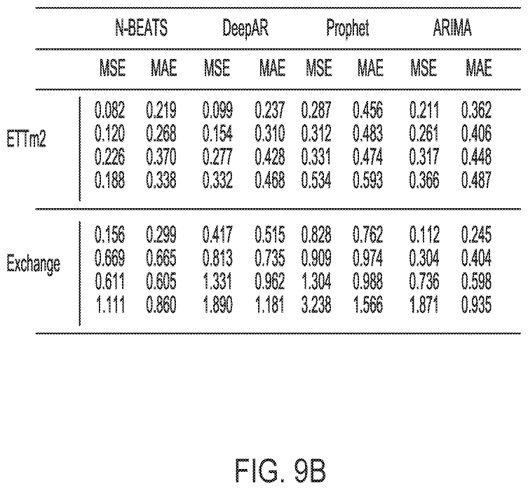

FIG. 9 illustrates exemplary performance for univariate data. In addition to comparing to models discussed above, additional models compared include N-BEATS as described in Oreshkin et. al., N-beats: Neural basis expansion analysis for interpretable time series forecasting, In International Conference on Learning Representations, 2020; DeepAR as described in Salinas et. al., Deepar: Probabilistic forecasting with autoregressive recurrent networks; Prophet as described in Taylor and Letham, Forecasting at scale, The American Statistician, 72(1):37-45, 2018; and an auto-regressive integrated moving average (ARIMA). As illustrated, DeepTIMe achieves competitive results on the univariate benchmark despite its simple architecture compared to the baselines comprising complex fully connected architectures and computationally intensive Transformer architectures.

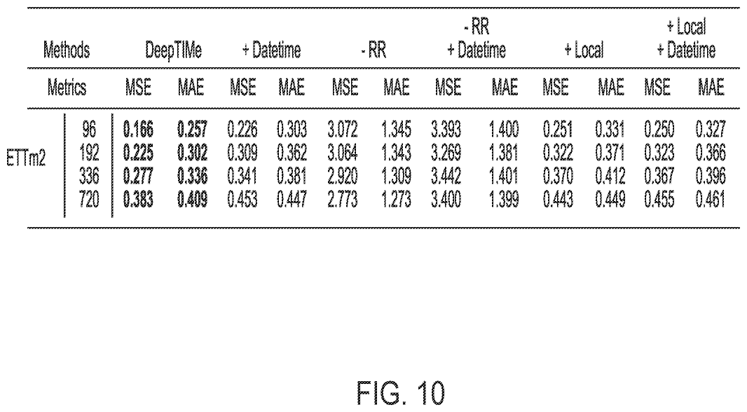

FIG. 10 illustrates exemplary performance of different embodiments of DeepTIMe. Each column header represents adding (+) some element or removing (−) some element from the baseline DeepTIMe framework. RR stands for the differentiable closed-form ridge regressor. Removing the ridge regressor refers to replacing this module with a simple linear layer trained via gradient descent across all training sampled (i.e., without meta-learning formulation). Local refers to training the model from scratch via gradient descent for each lookback window (ridge regressor again not used here, and there is no training phase). Datetime refers to datetime features. As a dataset may come with timestamps for each observation, datetime features may be constructed, such as month of the year, week of the year, hour of the day, minute of the hour, etc. Each feature may be initially stored as an integer value, which is subsequently normalized to a [0,1] range. Depending on the data sampling frequency, the appropriate features can be chosen.

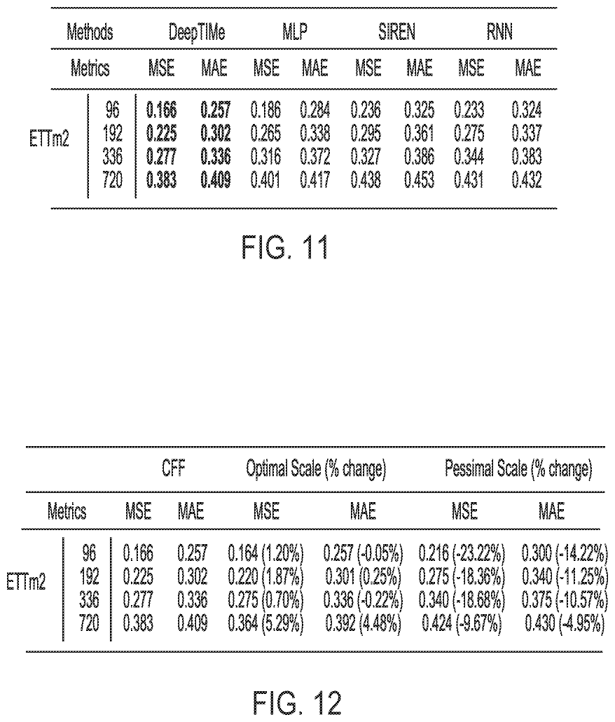

FIG. 11 represents exemplary performance results on different backbone models. DeepTIMe refers to the approach described herein with a neural network with random fourier features sampled from a range of scales. MLP refers to replacing the random Fourier features with a linear map from input dimension to hidden dimension. SIREN refers to a neural network with periodic activations as proposed in Sitzmann et aL, Implicit neural representations with periodic activation functions, Advances in Neural Information Processing Systems, 33:7462-7473, 2020. RNN refers to an autoregressive recurrent neural network (inputs are the time-series values, yₜ). All approaches in FIG. 11 include a differentiable closed-form ridge regressor. As shown, there is a degradation in performance when the random Fourier features layer is removed. DeepTIMe outperforms the SIREN variant. Finally, DeepTIMe outperforms the RNN variant. This is a direct comparison between auto-regressive and time-index models, and highlights the benefits of a time-index model.

FIG. 12 represents exemplary performance results comparing concatenated Fourier features against the optimal and pessimal scales as obtained from a hyperparameter sweep. As discussed above, concatenated Fourier features allows for similar performance without the need to fine-tune hyperparameters. Also showm are calculated change in performance betweeen concatenated Fourier features and the optimal and pessimal scales, where a positive percentage refers to a concatenated Fourier features underperforming, and negative percentage refers to concatenated Fourier features outperforming, calculated as % change=(MSE_{CFF}−MSE_{Scale})/MSE_{Scale}. As shown, concataenated Fourier features achieves extremely low deviation from the optimal scale across all settings, yet retains the upside of avoiding an expensive hyperparameter tuning phase.

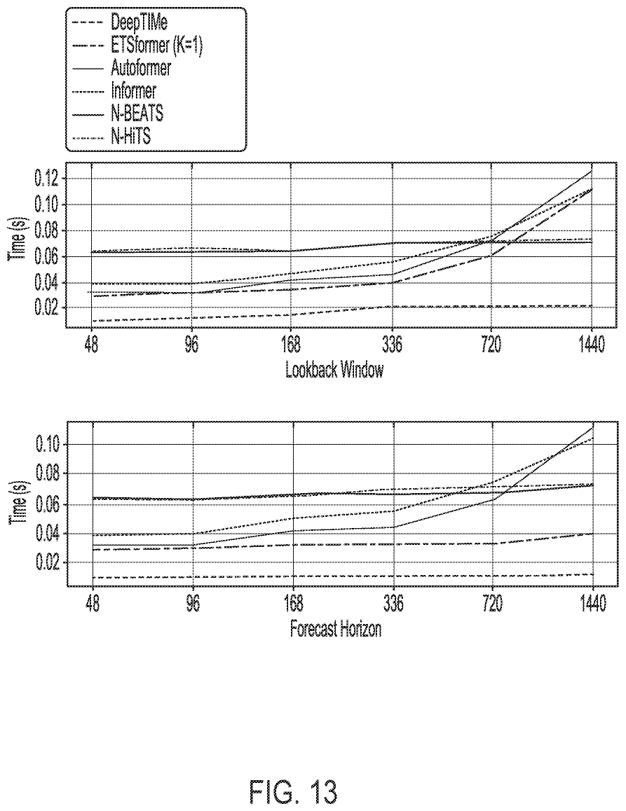

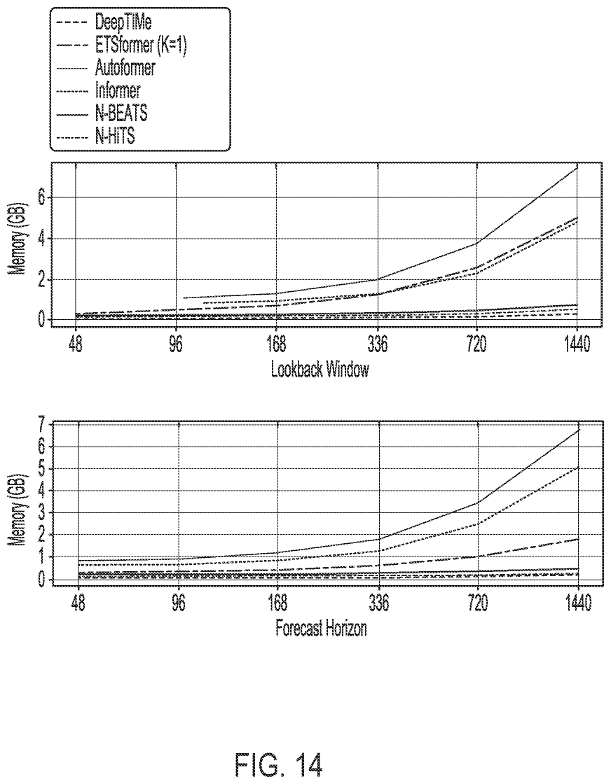

FIG. 13 illustrates the efficiency in training time of DeepTIMe. FIG. 14 illustrates the efficiency of memory in training using the DeepTIMe framework. As shown, DeepTIMe is highly efficient both in terms of time and memory, even when compared to efficient Transformer models proposed for long sequence time-series forecasting, as well as fully connected models.

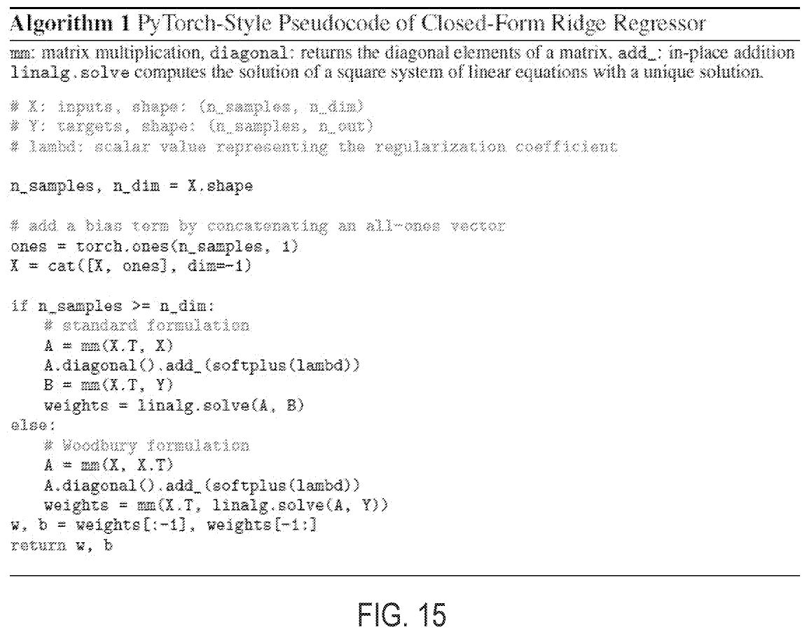

FIG. 15 provides an exemplary pseudo-code algorithm for a closed-form ridge regressor according to some embodiments. As discussed above, ridge regressor 104 may be optimized via a closed-form solver. The solver solves the optimization problem:

$${W}_{T}^{( K ) *} = {arg min}_{W} {‖ {Z}_{t - L : t} W - {Y}_{t - L : t} ‖}^{2} + λ {‖ W ‖}^{2} = {( {Z}_{t - L : t}^{T} {Z}_{t - L : t} + λ I )}^{- 1} {Z}_{t - L : t}^{T} {Y}_{t - L : t}$$

The closed-form solution is differentiable, which enables gradient updates on the parameters of the meta learner ϕ. As shown, a bias term can be included for the closed-form ridge regressor by appending a scalar 1 to the feature vector g_{ϕ}(τ).

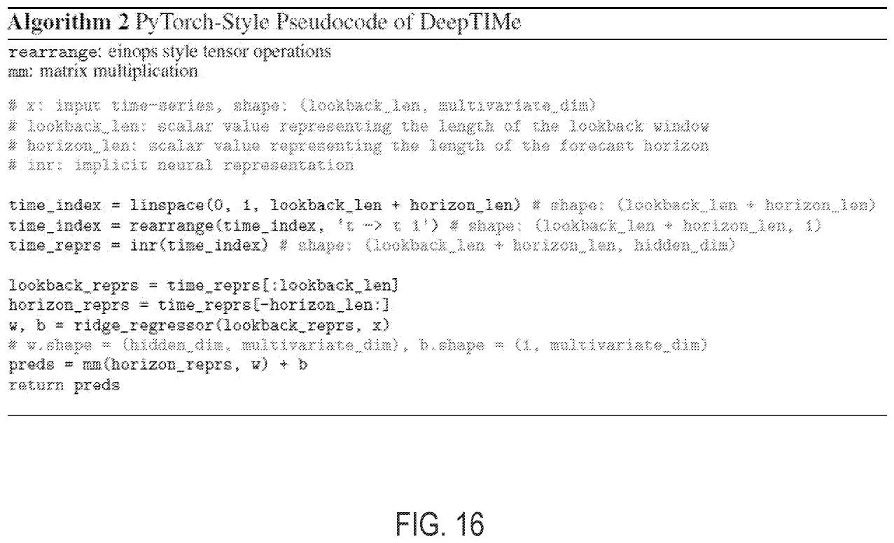

FIG. 16 provides an exemplary pseudo-code algorithm for the DeepTIMe framework according to some embodiments. As discussed above, training is performed iteratively with inner and outer optimization loops. As shown, the time-index is normalized over a lookback and horizon window of the time-series data.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method of training a time series data forecasting model, the method comprising:
receiving a time-series data sequence including first time series data over a first lookback time window and second time series data over a first horizon time window following the lookback time window in time;
generating, by a neural network parametrized by first parameters of a final layer and second parameters of other layers, first outputs based on an input of normalized time coordinates from the first lookback time window;
updating the first parameters of the final layer based on a first training objective comparing the first time series data and the first outputs of the neural network while keeping the second parameters of the other layers frozen;
generating, by the neural network parametrized with updated first parameters and the second parameters that have been frozen, second outputs based on an input of normalized time coordinates from the first horizon time window; and
updating the second parameters based on a second training objective comparing the second time series data and second outputs of the neural network subject to the updated first parameters of the final layer.

2. The method of claim 1, further comprising:
generating, by the neural network, third outputs based on an input of normalized time coordinates from a second lookback time window of the time-series data sequence; and
updating the first parameters of the final layer based on the first training objective comparing third time series data over the second lookback time window and the third outputs of the neural network; while keeping the second parameters of the other layers frozen;

3. The method of claim 2, further comprising:
generating, by the neural network, fourth outputs based on an input of normalized time coordinates from a second horizon time window; and
updating the second parameters based on the second training objective comparing fourth time series data over the second horizon time window and the fourth outputs of the neural network subject to the updated first parameters of the final layer.

4. The method of claim 1, wherein the first training objective is computed by summing a cross entropy between the first time series data and the first outputs of the neural network over the first lookback time window.

5. The method of claim 1, wherein the second training objective is computed by summing a cross entropy between the second time series data and the second outputs of the neural network over the first horizon time window.

6. The method of claim 1, wherein the input of normalized time coordinates from the first lookback time window are modified by one or more sinusoid functions.

7. The method of claim 1, wherein the input of normalized time coordinates from the first lookback time window are modified by a concatenation of sinusoid functions.

8. A system for training a time series data forecasting model, the system comprising:
a memory that stores the time series data forecasting model and a plurality of processor executable instructions;
a communication interface that receives a time-series data sequence including first time series data over a first lookback time window and second time series data over a first horizon time window following the lookback time window in time; and
one or more hardware processors that read and execute the plurality of processor-executable instructions from the memory to perform operations comprising:
generating, by a neural network parametrized by first parameters of a final layer and second parameters of other layers, first outputs based on an input of normalized time coordinates from the first lookback time window;
updating the first parameters of the final layer based on a first training objective comparing the first time series data and the first outputs of the neural network while keeping the second parameters of the other layers frozen;
generating, by the neural network parametrized with updated first parameters and the second parameters that have been frozen, second outputs based on an input of normalized time coordinates from the first horizon time window; and
updating the second parameters based on a second training objective comparing the second time series data and second outputs of the neural network subject to the updated first parameters of the final layer.

9. The system of claim 8, wherein the operations further comprise:
generating, by the neural network, third outputs based on an input of normalized time coordinates from a second lookback time window of the time-series data sequence; and
updating the first parameters of the final layer based on the first training objective comparing third time series data over the second lookback time window and the third outputs of the neural network; while keeping the second parameters of the other layers frozen;

10. The system of claim 9, wherein the operations further comprise:
generating, by the neural network, fourth outputs based on an input of normalized time coordinates from a second horizon time window; and
updating the second parameters based on the second training objective comparing fourth time series data over the second horizon time window and the fourth outputs of the neural network subject to the updated first parameters of the final layer.

11. The system of claim 8, wherein the first training objective is computed by summing a cross entropy between the first time series data and the first outputs of the neural network over the first lookback time window.

12. The system of claim 8, wherein the second training objective is computed by summing a cross entropy between the second time series data and the second outputs of the neural network over the first horizon time window.

13. The system of claim 8, wherein the input of normalized time coordinates from the first lookback time window are modified by one or more sinusoid functions.

14. The system of claim 8, wherein the input of normalized time coordinates from the first lookback time window are modified by a concatenation of sinusoid functions.

15. A non-transitory machine-readable medium comprising a plurality of machine-executable instructions which, when executed by one or more processors, are adapted to cause the one or more processors to perform operations comprising:
receiving a time-series data sequence including first time series data over a first lookback time window and second time series data over a first horizon time window following the lookback time window in time;
generating, by a neural network parametrized by first parameters of a final layer and second parameters of other layers, first outputs based on an input of normalized time coordinates from the first lookback time window;
updating the first parameters of the final layer based on a first training objective comparing the first time series data and the first outputs of the neural network while keeping the second parameters of the other layers frozen;
generating, by the neural network parametrized with updated first parameters and the second parameters that have been frozen, second outputs based on an input of normalized time coordinates from the first horizon time window; and
updating the second parameters based on a second training objective comparing the second time series data and second outputs of the neural network subject to the updated first parameters of the final layer.

16. The non-transitory machine-readable medium of claim 15, wherein the operations further comprise:
generating, by the neural network, third outputs based on an input of normalized time coordinates from a second lookback time window of the time-series data sequence; and
updating the first parameters of the final layer based on the first training objective comparing third time series data over the second lookback time window and the third outputs of the neural network; while keeping the second parameters of the other layers frozen;

17. The non-transitory machine-readable medium of claim 16, wherein the operations further comprise:
generating, by the neural network, fourth outputs based on an input of normalized time coordinates from a second horizon time window; and
updating the second parameters based on the second training objective comparing fourth time series data over the second horizon time window and the fourth outputs of the neural network subject to the updated first parameters of the final layer.

18. The non-transitory machine-readable medium of claim 15, wherein the first training objective is computed by summing a cross entropy between the first time series data and the first outputs of the neural network over the first lookback time window.

19. The non-transitory machine-readable medium of claim 15, wherein the second training objective is computed by summing a cross entropy between the second time series data and the second outputs of the neural network over the first horizon time window.

20. The non-transitory machine-readable medium of claim 15, wherein the input of normalized time coordinates from the first lookback time window are modified by one or more sinusoid functions.
